(19) United States
(12) Patent Application Publication
(10) Pub. No.: US 2015/0300785 A1
(43) Pub. Date: Oct. 22, 2015

(54) ENERGY ABSORBING DEVICE FOR A SEAT OF A VEHICLE

(71) Applicant: SURVIVABILITY SOLUTIONS LLC, Sterling Heights, MI (US)

(72) Inventors: Ronald C. LAMPARTER, Grosse Pointe Shores, MI (US); Sorin COMAN, Waterford, MI (US); Hugh S. MCLEOD, Clinton Township, MI (US); Thomas MESSNER, Grand Blanc, MI (US)

(73) Assignee: SURVIVABILITY SOLUTIONS LLC, Sterling Heights, MI (US)

(21) Appl. No.: 14/648,424

(22) PCT Filed: Nov. 27, 2013
(86) PCT No.: PCT/US2013/072407

§ 371 Date: May 29, 2015

Related U.S. Application Data
(60) Provisional application No. 61/797,105, filed on Nov. 29, 2012.
(60) Provisional application No. 61/787,835, filed on Mar. 15, 2013.

(51) Int. Cl. F41H 7/04; B60N 2/50; B60N 2/42; B60N 2/427

(52) U.S. Cl. CPC F41H 7/046; B60N 2/427; B60N 2/502; B60N 2/509; B60N 2/4242

(57) ABSTRACT

A seat supports an occupant of a vehicle and absorbs a force between the occupant and the vehicle created by relative movement between the occupant and the vehicle. The seat includes a seat bottom frame and a seat back supported on the seat bottom frame. A support moveably supports the seat bottom frame. An energy absorbing device is coupled to the support and the seat bottom frame. The energy absorbing device is configured to absorb energy during relative movement of the seat bottom frame and the support. A pin extends from one of the seat bottom frame and the support and the other of the seat bottom frame and the support defines a slot slideably receiving the pin. The slot extends along an axis for limiting relative movement of the seat bottom frame and the support along the axis.

### CROSS-REFERENCE TO RELATED APPLICATIONS

The subject patent application claims priority to and all the benefits of U.S. Provisional Patent Application No. 61/797,105 filed on Nov. 29, 2012 and U.S. Provisional Patent Application No. 61/787,835 filed on Mar. 15, 2013, each of which are herein incorporated by reference in their entirety.

### BACKGROUND OF THE INVENTION

1. Field of the Invention

The present invention relates to a seat for supporting an occupant of a vehicle and absorbing a force between the occupant and the vehicle created by relative movement between the occupant and the vehicle.

2. Description of the Related Art

Vehicles are widely used for military purposes, especially in recent military conflicts, to transfer soldiers, to enter combat areas, to patrol areas, etc. Such vehicles can be exposed to blasts resulting from an explosive such as an improvised explosive device (IED), a mine, a grenade, etc. Forces from such blasts are transferred through the vehicle to the occupants. The vibration and/or reverberation of the blast through the vehicle can injure the occupants.

These vehicles can be armored to shield the occupants from such blasts but the armor of the armored vehicle is designed to remain rigid during a blast to deflect the blast and preserve the structural integrity of the vehicle, or at least the portion of the vehicle housing occupants. Unlike civilian automobiles that are designed to crush to absorb forces resulting from an automobile crash, the armor on the armored vehicle, due to its rigidity, does not crush and thus does not absorb forces resulting from the blast. As such, although the armor protects the occupants by maintaining structural rigidity of the vehicle, the blast vibrates and/or reverberates through the vehicle because the armor does not deform to absorb the energy of the blast. This vibration and/or reverberation through the vehicle can injure the occupant. For example, if the blast originates below the vehicle, the blast can vibrate and/or reverberate through the floor of the vehicle. In such a scenario, the occupant can be harmed if this vibration and/or reverberation is transferred directly to the occupant through the floor and/or the seat.

Further, whether the vehicle is armored or not, much of the technology for absorbing energy in a civilian automobile during an automobile accident is not suitable for absorbing energy from an explosive blast. As one example, conventional civilian automobiles are equipped with airbags that inflate upon crash of the automobile. The airbag can inflate within 5 milliseconds. Due to the speeds of typical civilian automobile accidents and/or due to the crushing of the automobile to absorb energy, the immediate need for inflation of the airbag is not necessary and the 5 millisecond delay is acceptable. In other words, in a civilian automobile accident, the inflation of the airbag is typically not needed earlier than 5 milliseconds after the crash. However, in the case of an explosive blast, the magnitude of the blast can be such that the forces of the blast are almost instantaneously transferred to the occupant, i.e., forces that can harm the occupant are transferred through the armored vehicle in less than 5 milliseconds. Further, in the case of an armored vehicle, for example, the armor is relatively rigid and does not absorb much, if any, forces. As such, much or all of the force resulting from the blast is transferred virtually instantaneously through the vehicle to the occupant. As such, the airbags used in civilian automobiles cannot react quickly enough due to the 5 millisecond delay associated with the civilian automobile airbags.

In addition to generating initial forces acting on the vehicle, the blast can also cause the vehicle to become airborne. The occupant can suffer injuries relating to the landing of the vehicle on the ground, i.e., the “slam down.”

### SUMMARY OF THE INVENTION AND ADVANTAGES

The present invention includes a seat for supporting an occupant of a vehicle and absorbing a force between the occupant and the vehicle created by relative movement between the occupant and the vehicle. The seat comprises a seat bottom frame and a seat back supported on the seat bottom frame. A support is disposed below and moveably supports the seat bottom frame. An energy absorbing device is disposed between and is coupled to the support and the seat bottom frame and is configured to absorb energy during relative movement of the seat bottom frame and the support. A pin extends from one of the seat bottom frame and the support and the other of the seat bottom frame and the support defines a slot slideably receiving the pin. The slot extends along an axis for limiting relative movement of the seat bottom frame and the support along the axis.

Due to the slot and pin limiting relative movement of the seat bottom frame and the support along the axis, the space in the vehicle necessary to house and properly operate the seat is reduced. In other words, the limitation of movement of the seat bottom frame and support along the axis advantageously makes the operation of the seat while absorbing the force more compact, which is beneficial for packaging restraints inside the vehicle. In addition, by limiting relative movement of the seat bottom frame and support along the axis, the slot and pin control the loading of the energy absorbing device in a repeatable manner, thus making it easier to properly tune the energy absorbing device to absorb a predetermined force.

The present invention also includes a seat for supporting an occupant of a vehicle and absorbing a force between the occupant and the vehicle created by relative movement between the occupant and the vehicle. The seat comprises a seat bottom frame for mounting to the vehicle and a seat pan moveably coupled to the seat bottom frame for supporting the occupant. A seat belt includes a retractor and webbing extending from the retractor for extension across the occupant to retain the occupant on the seat pan. A link is pivotably coupled to the seat pan and to the seat bottom frame and guides movement of the seat pan relative to the seat bottom frame toward the webbing of the seat belt when the seat pan moves relative to the seat bottom frame for pre-tensioning the webbing relative to the occupant.

Since the link is pivotably coupled to the seat pan and the seat bottom frame and guides movement of the seat pan relative to the seat bottom frame, the relative movement of the seat pan and the seat bottom frame is repeatable. Since the pre-tensioning of the webbing relative to the occupant is dependant on the relative movement between the seat pan and the seat bottom frame, this repeatable movement is advantageous in designing of the amount of pre-tensioning in the webbing relative to the occupant. The pre-tension of the webbing relative to the occupant retains the occupant in the seat to minimize the risk of whiplash of the occupant and to minimize the risk of “submarining” underneath the webbing, i.e., sliding underneath the webbing.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a vehicle partially cut away to show a seat in the vehicle;

FIG. 2 is a front perspective view of a portion of the seat;

FIG. 3 is a partially exploded view of a portion of the seat;

FIG. 4 is a cross-sectional view of the seat at rest in the absence of a force applied to the seat;

FIG. 4A is a magnified view of a resilient member of FIG. 4 including layered members;

FIG. 5 is a partial cross-sectional view of the seat when a force of a first magnitude is applied to the seat and the seat pan moves away from a seat back to pre-tension webbing of a seat belt against the occupant;

FIG. 6A is a side view of a seat pan and a seat bottom frame of FIG. 4 in the absence of a force applied to the seat;

FIG. 6B is a side view of the seat pan and the seat bottom frame and activation of a first energy absorbing device when a force of a first magnitude is initially applied to the seat;

FIG. 6C shows a progression of movement of the seat pan and the seat bottom frame after the position shown in FIG. 6B during application of the force of the first magnitude;

FIG. 6D shows a progression of movement of the seat pan and the seat bottom frame after the position shown in FIG. 6C during application of the force of the first magnitude;

FIG. 6E shows a progression of movement of the seat pan and the seat bottom frame after the position shown in FIG. 6D during application of the force of the first magnitude;

FIG. 7 is a cross-sectional view of the seat when a force of a second magnitude is applied to the seat and activates a second energy absorbing device;

FIG. 8 is a cross-sectional view of the seat when a force of a third magnitude is applied to the seat and activates a third energy absorbing device;

FIG. 9A is a side view of the seat with an active head restraint in a stowed position and with another embodiment of the second energy absorbing device; and

FIG. 9B is a side view of the seat of FIG. 9A with the active head restraint in a deployed position.

### DETAILED DESCRIPTION OF THE INVENTION

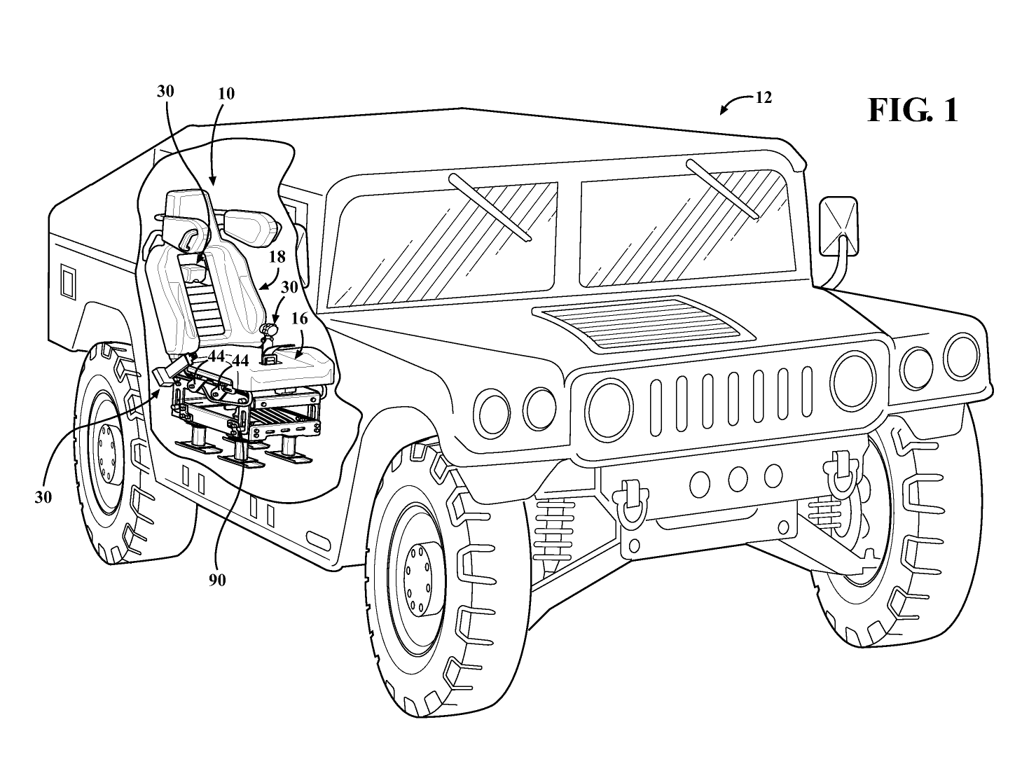

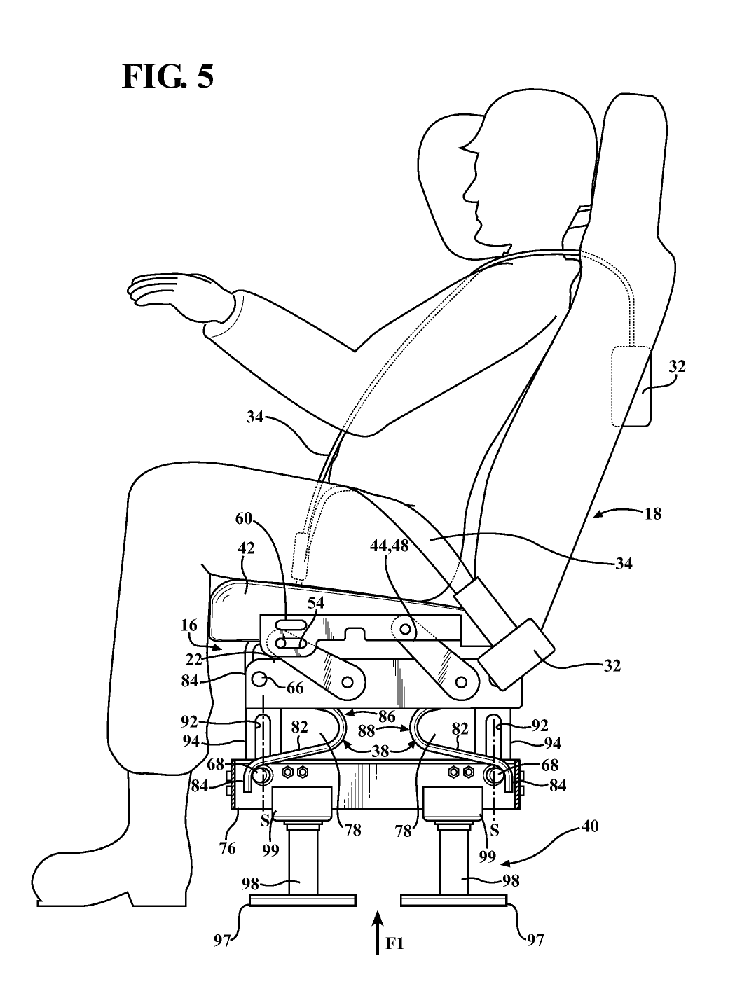

With reference to the figures, wherein like numerals indicate like parts throughout the several views, a blast attenuation seat is shown generally at 10 and is referred to hereinafter as “the seat 10.” As shown in FIG. 1, the seat 10 is mounted in a vehicle 12 for supporting an occupant (shown in FIG. 5, for example) of the vehicle 12 and absorbing a force between the occupant and the vehicle 12 created by relative movement between the occupant and the vehicle 12.

The seat 10 is typically mounted in a military vehicle but can also be mounted in a non-military vehicle such as, for example, a law enforcement vehicle or a civilian vehicle. Whether the vehicle 12 is a military vehicle or otherwise, the vehicle 12 can be a land vehicle such as, for example, an automobile, a tank, a bus, a train, etc.; a water vehicle such as, for example, a boat or a submarine; or an air vehicle such as, for example, an airplane or helicopter. The seat 10 can be manufactured from light-weight material to fulfill aircraft requirements. Typical military uses of the seat 10 include, for example, armored vehicles and tanks. In any event, the seat 10 can be used in any location of the vehicle 12, i.e., driver seat, front passenger seat, rear seat, etc.

The seat 10 supports the occupant of the vehicle 12 and absorbs a force between the occupant and the vehicle 12 created by relative movement between the occupant and the vehicle 12. For example, the seat 10 absorbs the force transmitted through the vehicle 12 to the seat 10 from a blast that originates exterior to the vehicle 12 in order to minimize force exerted through the seat 10 to the occupant. The blast can be caused by, for example, an explosive such as an improvised explosive device, a mine, a grenade, etc. The blast can result from an explosive in or on the ground or in the air around the vehicle 12. As one example, the blast can result from the vehicle 12 moving over a buried explosive. As set forth further below, the blast can also cause the vehicle 12 to become airborne and/or flip sideways, forward, and/or rearward, in which case the seat 10 not only absorbs the force resulting from the initial blast but also absorbs additional forces resulting from the impact of the vehicle 12 on the ground. In any event, regardless of the location of the explosive and the effect of the explosive on the vehicle 12, the seat 10 absorbs the force transmitted through the vehicle 12 to the seat 10.

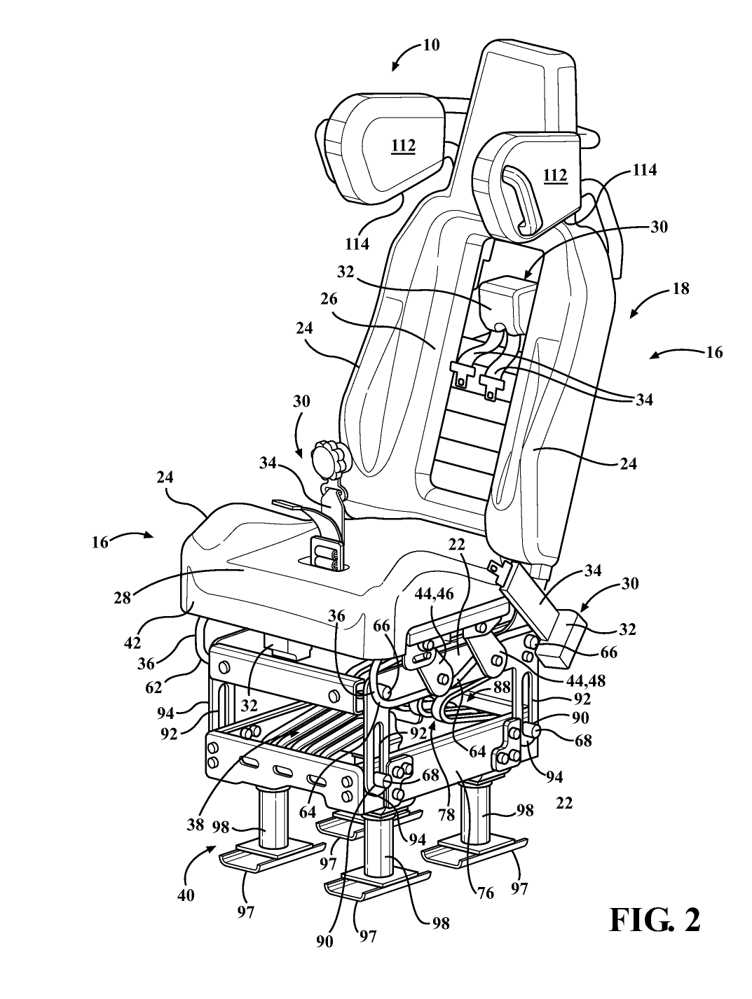

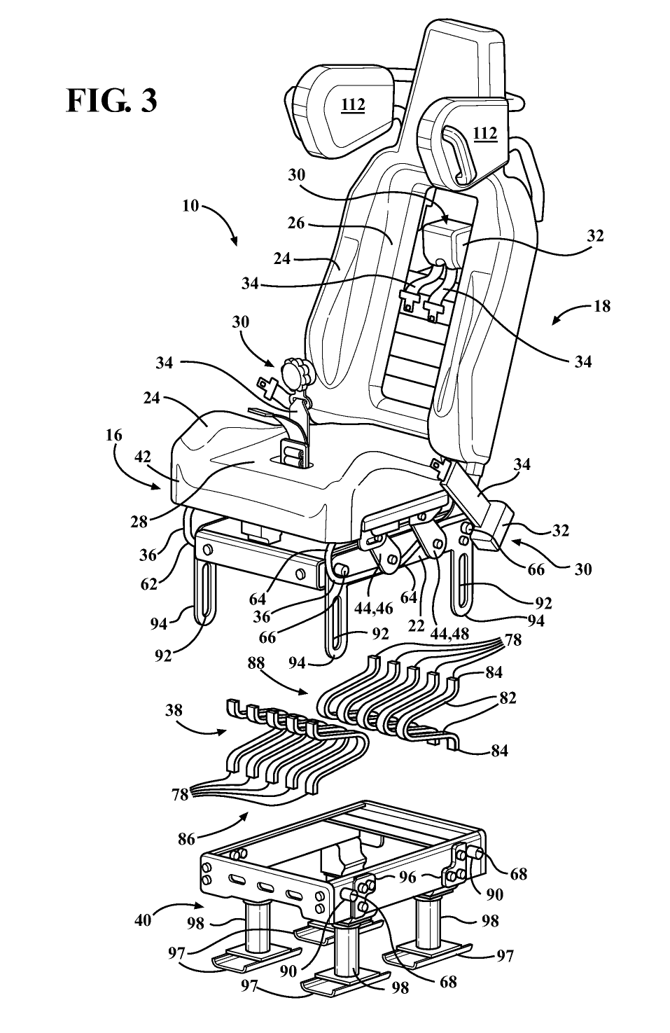

The seat 10 is configured to support a seated occupant (shown for example in FIG. 5). With reference to FIGS. 2 and 3, the seat 10 includes a seat bottom 16 and a seat back 18 extending upwardly from the seat bottom 16. The seat back 18 includes a seat back frame 20 and the seat bottom 16 includes a seat bottom frame 22. The seat back 18 is supported on the seat bottom frame 22. The seat bottom frame 22 extends from the seat back 18 along an axis A. Typically, the seat back frame 20 and the seat bottom frame 22 are formed of metal; however, it should be appreciated that the seat back frame 20 and the seat bottom frame 22 can be formed of any suitable material to provide proper support for the occupant. The seat 10 can be configured such that the seat back 18 can selectively pivot relative to the seat bottom 16 to position the seat 10 in a fold-flat position to, for example, support a litter carrier (not shown).

The seat bottom 16 and/or the seat back 18 can include bolsters 24. The bolsters 24 are configured to provide lateral support to the occupant to urge the occupant to remain in a seated position on the seat 10. For example, the bolsters 24 are sized, shaped, and oriented to prevent the occupant from moving laterally relative to the seat bottom 16 and/or seat back 18.

The bolsters 24 can be removably attached to the seat bottom 16 and/or seat back 18 so that the bolsters 24 can be selectively added to or removed from the seat bottom 16 and/or seat back 18. For example, the bolsters 24 can be selectively added to or removed from the seat bottom 16 and/or the seat back 18 in the field of operation of the vehicle 12. The bolsters 24 can be attached to the seat bottom 16 and/or seat back 18 with, for example, fasteners (not shown) such as any one or combination of threaded fasteners, clips, etc. The bolsters 24, alternatively, can be permanently affixed to the seat bottom 16 and/or seat back 18 such as, for example, by welding, integral formation (i.e., formation as a single unit as opposed to being subsequently attached), etc.

The seat bottom 16 can include an extender (not shown) that can be selectively extended and retracted relative to the seat bottom frame 22. The extender can be extended relative to the seat bottom frame 22, for example, to provide additional thigh support for an occupant wearing a backpack.

With reference to FIGS. 1-3, the seat back 18 can include a seat back cushion 26 mounted to the seat back frame 20 and the seat bottom 16 can include a seat bottom cushion 28 mounted to the seat bottom frame 22. The seat back cushion 26 and seat bottom cushion 28 are only partially shown in FIGS. 1-3 and 9A-B and are not shown in the remaining figures merely for illustrative purposes. Specifically, the seat back cushion 26 and the seat bottom cushion 28 typically include foam (not shown) covered by fabric (not shown). The foam and fabric typically cover the seat back frame 20 and the seat bottom frame 22. The foam and the fabric of the seat back cushion 26 can be the same type of material or a different type of material than the foam and the fabric of the seat bottom cushion 28.

When the force is exerted by the blast through the vehicle 12 to the seat 10, the foam compresses between the occupant and the seat bottom frame 22 and/or the seat back frame 20 to absorb at least a portion of the force to reduce or eliminate the magnitude of the force delivered to the occupant. The foam is typically resilient such that the foam returns to a pre-blast configuration after absorbing the force from the blast.

As set forth further below, the seat back 18 and/or the seat bottom 16 can include air bags (not shown) for inflation when the vehicle 12 is subjected to a force exceeding a predetermined force. In the alternative, or in addition, the seat back 18 and/or seat bottom 16 can include bladders (not shown) that are inflated with gas and are configured to rupture when subjected to a force exceeding a predetermined force. The bladders can be, for example, formed of a flexible polymeric material. The bladders can, for example, be configured to cushion the occupant upon “slam down,” i.e., when the vehicle 12 lands on the ground after being airborne in response to an explosion. The air bags or bladders can be disposed, for example, in the seat back cushion 26 and/or the seat bottom cushion 28 and/or the bolsters 24.

With reference to FIGS. 1-3 and 5, the seat 10 includes a seat belt 30. The figures show a five-point seat belt for exemplary purposes, but the seat belt 30 can be of any type, such as, for example, a three-point seat belt, without departing from the nature of the present invention. The seat belt 30 includes a retractor 32 and webbing 34 extending from the retractor 32 for extension across the occupant to retain the occupant on the seat 10, and specifically, on the seat pan 42. The seat belt 30 can include a second retractor 36 with the retractor 32 mounted to one of the seat back frame 20 and seat bottom frame 22 and the second retractor 36 also mounted on the same one of the seat back frame 20 and seat bottom frame 22 or mounted to the other of the seat back frame 20 and seat bottom frame 22.

The seat belt 30 is self-contained on the seat 10. In other words, the seat belt 30 is anchored to the seat 10, e.g., the seat back frame 20 and/or the seat bottom frame 22 thereby eliminating the need for anchoring the seat belt 30 to the vehicle body or floor. As such, the entire seat 10 can be installed into or removed from the vehicle 12 by merely disconnecting the base from the vehicle 12, i.e., without the need for disconnecting the seat belt 30 from the vehicle 12, so that the seat 10 is modular. The seat 10 can include one or more variable mounting brackets (not numbered) to enable the use of different seat belt styles, types, and/or manufacturers.

The seat back 18 defines a cutout 35 and the webbing 34 of the seat belt 30 extends through the cutout 35 for positioning over the shoulders of the occupant. The retractor 36 of the seat belt 30 is typically mounted adjacent the cutout 35, as shown in FIG. 1, for example. Specifically, a mount 37 can be mounted to the seat back frame 20 adjacent the cutout 35. The retractor 36 is mounted to the mount 37.

With reference to FIGS. 2-3, a first energy absorbing device 36, a second energy absorbing device 38, and a third energy absorbing device 40 are mounted to the seat bottom 16. As set forth further below, the first 36, second 38, and/or third 40 energy absorbing devices allow movement of at least one of the seat bottom 16 and the seat back 18 relative to the vehicle 12 in response to the force of the blast and absorb at least a portion of the force. The first 36, second 38, and third 40 energy absorbing devices are active, i.e., instantaneously respond to force. The seat 10 is tunable in that the first 36, second 38, and third 40 energy absorbing devices can each be designed so that, in combination, the first 36, second 38, and third 40 energy absorbing devices can absorb energy over a large range of forces.

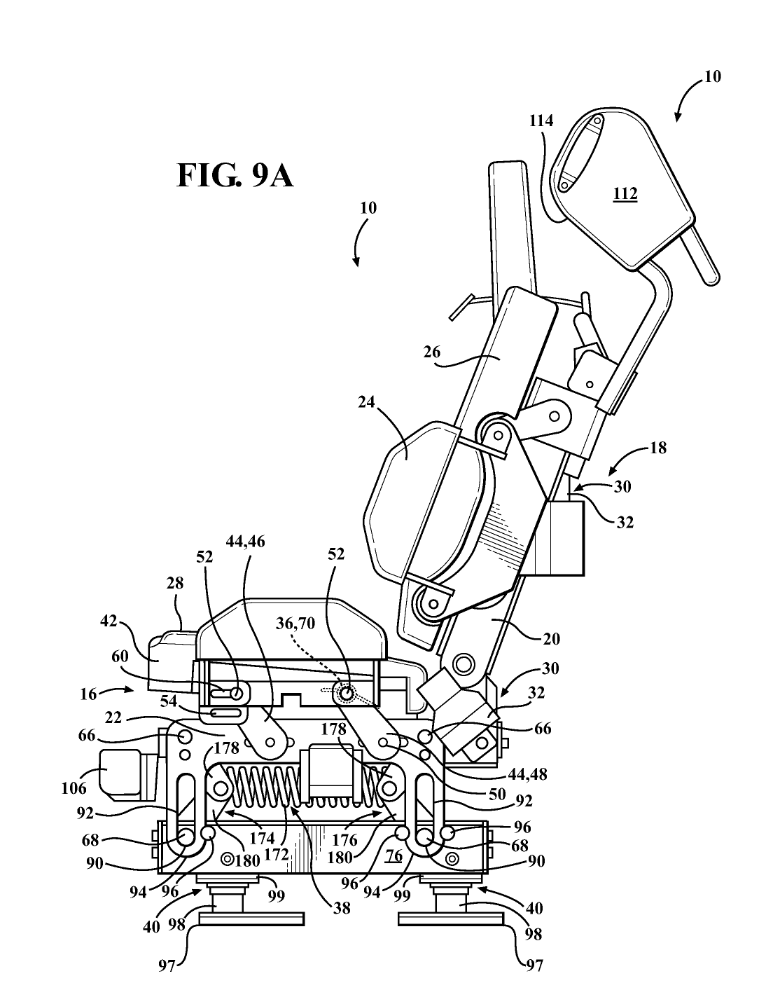

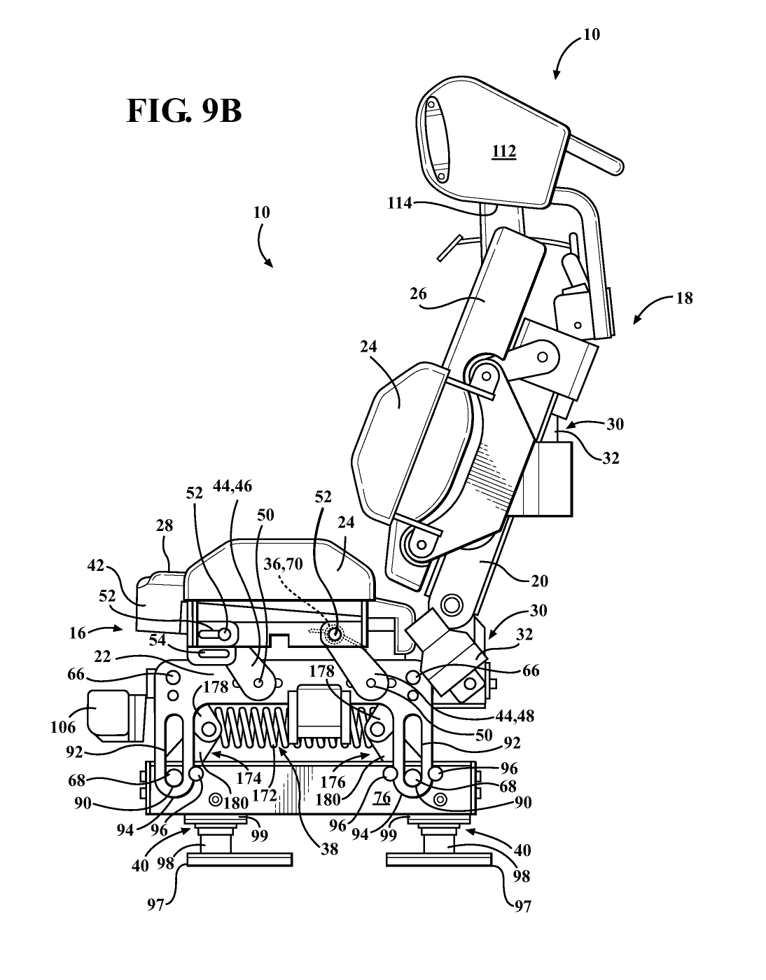

The first energy absorbing device 36 can be coupled to at least one of the seat bottom 16 and/or the seat back 18 for absorbing at least a portion of the force of the blast when a magnitude of the force reaches a first magnitude F1. As shown in FIGS. 1-8, the seat bottom 16 includes the first energy absorbing device 36. As shown in FIGS. 9A-9B, both the seat bottom 16 and the seat back 18 include first energy absorbing devices 36. It should also be appreciated that only the seat back 18, and not the seat bottom 16, can include the first energy absorbing device 36. The first energy absorbing device 36 of the seat back 18 and the seat bottom 16 is typically disposed beneath the seat back cushion 26 and the seat bottom cushion 28, respectively. In other words, the foam and fabric of the seat back cushion 26 and the seat bottom cushion 28 covers the first energy absorbing device 36 of the seat bottom 16 and the seat back 18, respectively. As set forth above, the foam and fabric of the seat back cushion 26 and the seat bottom cushion 28 is not shown in the figures in order to show the other features of the seat 10.

The second energy absorbing device 38 can be coupled to at least one of the seat bottom 16 and/or the seat back 18 for absorbing at least a portion of the force of the blast when a magnitude of the force reaches a second magnitude F2 greater than the first magnitude F1 and the third energy absorbing device 40 for absorbing for absorbing at least a portion of the force when a magnitude of the force exceeds a third magnitude F3 greater than the second magnitude F2. As shown in FIGS. 2-4, the seat bottom 16 includes the second energy absorbing device 38 and the third energy absorbing device 40. It should be appreciated that, while not shown in the figures, the seat back 18 can include the second 38 and third 40 energy absorbing devices.

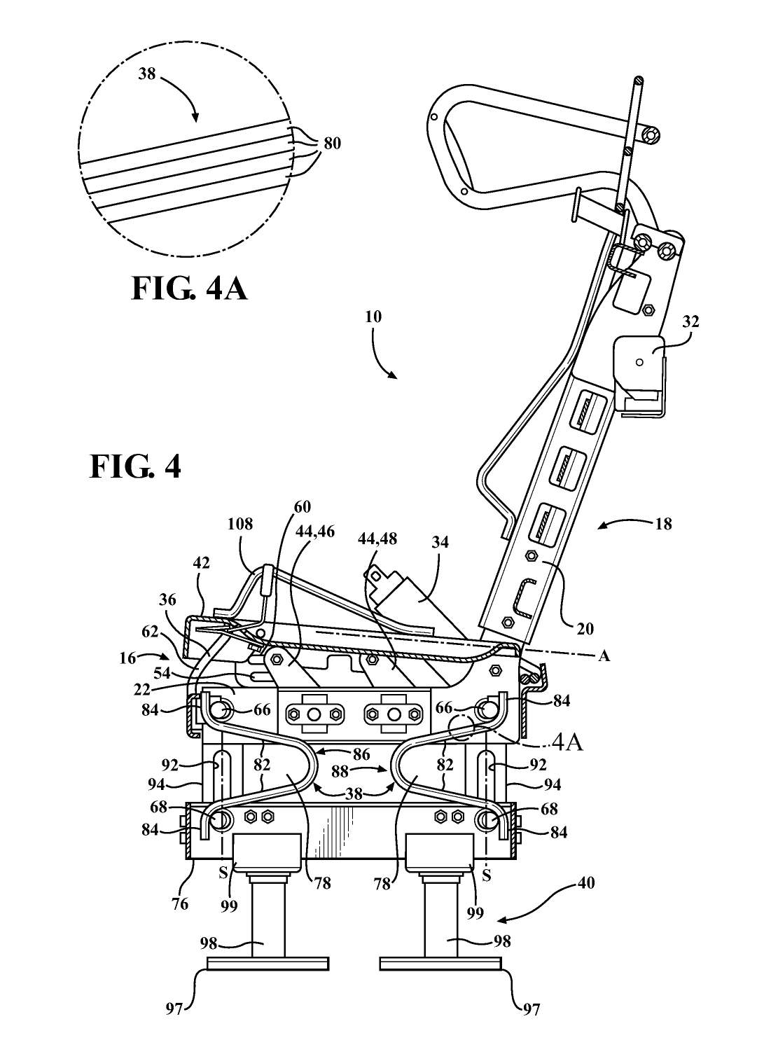

FIGS. 5-8 show the seat 10 reacting to the forces of the first magnitude F1, second magnitude F2, and third magnitude F3. FIG. 4 shows the seat 10 at rest, i.e., in the absence of a force of the first magnitude F1 or greater. The first 36, second 38, and third 40 energy absorbing devices can be designed such that the first magnitude F1, the second magnitude F2, and the third magnitude F3 can have any numerical measurement or range of numerical measurements. For example, the first magnitude F1 of the force, i.e., the magnitude that activates the first energy absorbing device 36, is typically between and 100 G. The second magnitude F2 of the force, i.e., the magnitude that activates the second energy absorbing device 38, is typically 100 and 300 G. The third magnitude F3 of the force, i.e., the magnitude that activates the third energy absorbing device 40, typically has a magnitude of between 300 and 550 G.

The first 36, second 38, and third 40 energy absorbing devices are arranged to function in series. In other words, the first 36, second 38, and third 40 energy absorbing devices each respectively absorb progressively larger forces. The differently, if the force exceeds the range of the first energy absorbing device 36, the first energy absorbing device 36 absorbs a portion of the force and transfers a portion of the force to the second energy absorbing device 38. Likewise, if the force exceeds the range of the second energy absorbing device 38, the first 36 and second 38 energy absorbing devices absorb a portion of the force and the second energy absorbing device 38 transfers a portion of the force to the third energy absorbing device 40. If the force reaches the second magnitude F2, the first energy absorbing device 36 and the second energy absorbing device 38 can react to the force in any order, i.e., the first energy absorbing device 36 can react before, after, or simultaneously with the second energy absorbing device 38. Likewise, if the force reaches the third magnitude F3, the first energy absorbing device 36, the second energy absorbing device 38, and the third energy absorbing device 40 an react to the force in any order.

The first energy absorbing device 36 is configured to absorb at least a portion of the force when the force reaches the first magnitude F1, i.e., during a blast, the first energy absorbing device 36 is activated and absorbs at least a portion of the force when the force reaches the first magnitude F1. If, on the other hand, the force is smaller than the first magnitude F1, then the first energy absorbing device 36 remains deactivated and does not absorb any of the force. The first energy absorbing device 36 can be loaded to a completely loaded state, in which state the first energy absorbing device 36 does not absorb additional force. Typically, the first energy absorbing device 36 reaches the fully loaded state at a magnitude of the force at least as high as the second magnitude F2.

The second energy absorbing device 38 is configured to absorb at least a portion of the force when the magnitude of the force reaches the second magnitude F2. If the force exceeds the second magnitude F2, the second energy absorbing device 38 is activated and, in addition to the activation of the first energy absorbing device 36, absorbs at least a portion of the force. If, on the other hand, the force remains smaller than the second magnitude F2, then the second energy absorbing device 38 remains deactivated and does not absorb any of the force. The second energy absorbing device 38 can be loaded to a completely loaded state, in which state the second energy absorbing device 38 does not absorb additional force. Typically, the second energy absorbing device 38 reaches the fully loaded state at a magnitude of the force at least as high as the third magnitude F3.

The third energy absorbing device 40 is configured to absorb at least a portion of the force when the force reaches the third magnitude F3. If the force exceeds the third magnitude F3 and the second energy absorbing device 38 reaches the completely loaded state, the third energy absorbing device 40 is activated and, in addition to the activation of the first 36 and second 38 energy absorbing devices, absorbs at least a portion of the force. If, on the other hand, the force remains smaller than the third magnitude F3, then the third energy absorbing device 40 remains deactivated and does not absorb any of the force.

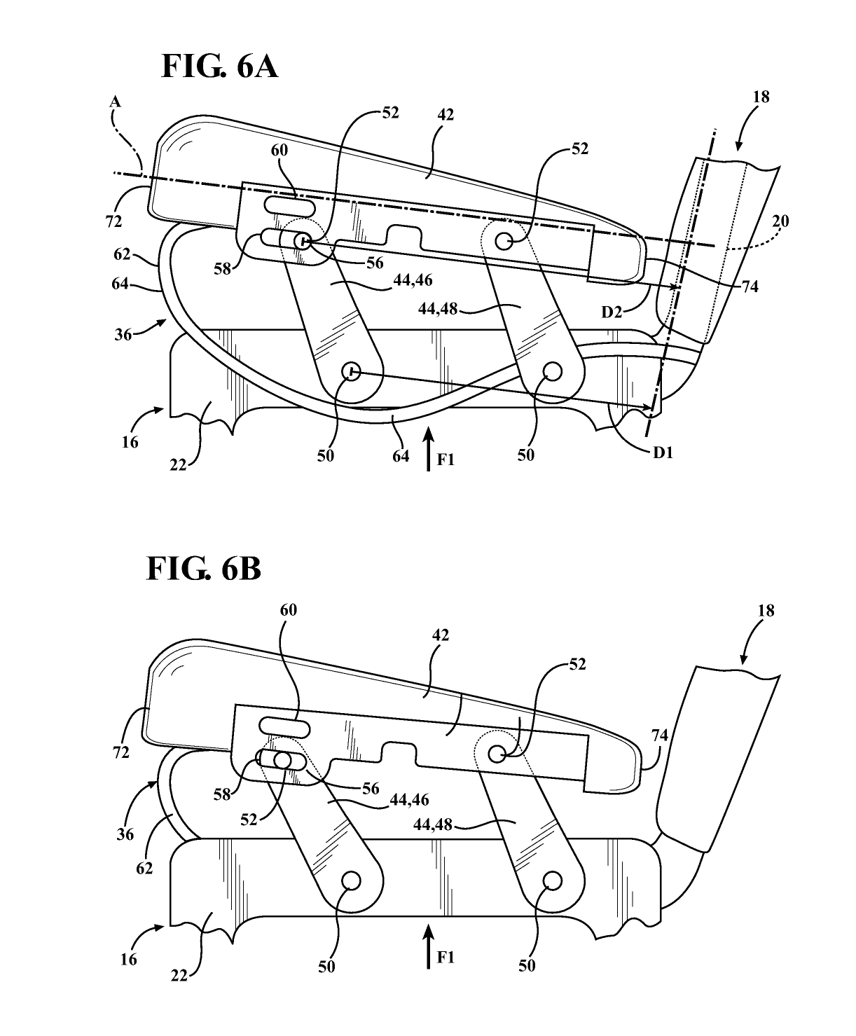

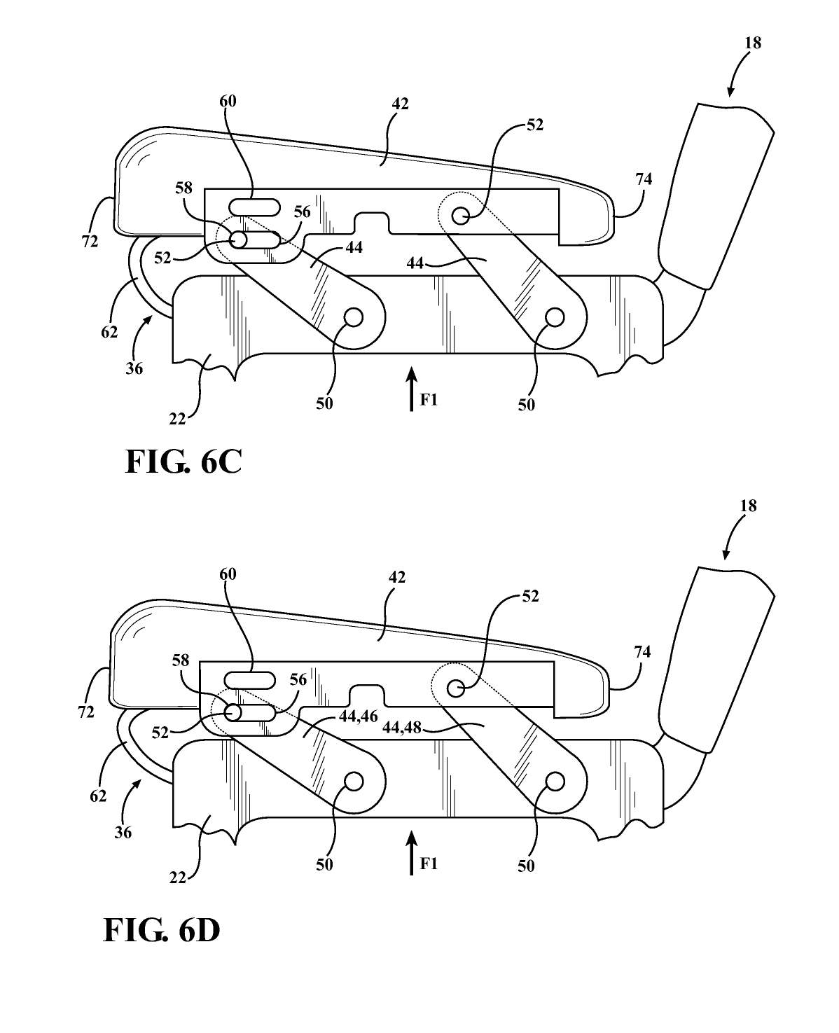

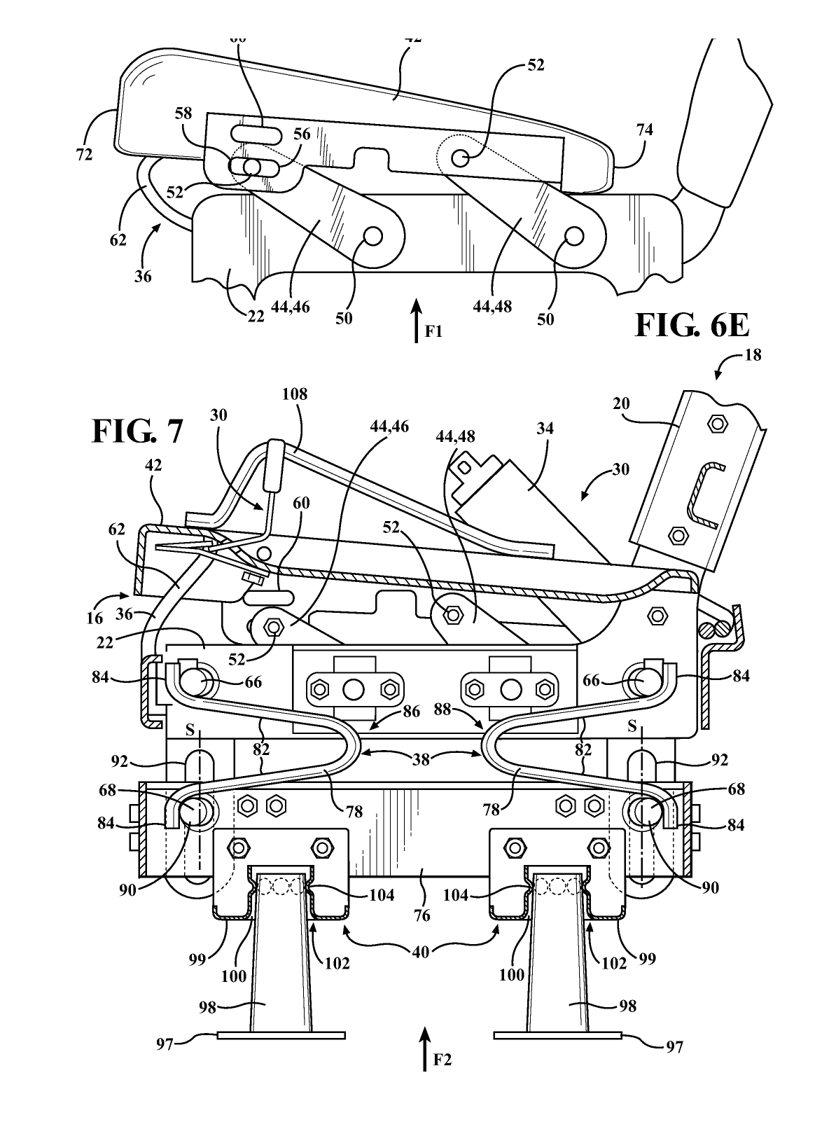

With reference to FIG. 2, a seat pan 42 is spaced from the seat bottom frame 22. The seat pan 42 is connected to the seat bottom frame 22 with a link 44 pivotably coupled to the seat pan 42 and to the seat bottom frame 22. The link 44 guides movement of the seat pan 42 relative to the seat bottom frame 22. Specifically, as set forth further below, the link 44 guides the seat pan 42 away from the seat bottom frame 22 when the seat pan 42 moves relative to the seat bottom frame 22. Typically, four links 44 connect the seat pan 42 to the seat bottom frame 22, as shown in the figures. With reference to FIGS. 6A-E, a first link 46 and a second link 48 are generally aligned with each other and spaced from each other along the axis A. Alternatively, any number of links 44 can connect the seat pan 42 to the seat bottom frame 22 without departing from the nature of the present invention.

Each link 44 includes a first pivot point 50 coupled to the seat pan 42 and a second pivot point 52 coupled to the seat bottom frame 22. The first pivot point 50 is spaced a first distance D1 from the seat back 18 along the axis A and the second pivot point 52 is spaced a second distance D2 from the seat back 18 along the axis A. The second distance D2 is greater than the first distance D1. With reach link 46, 48, the second pivot point 52 is spaced above the first pivot point 50.

As set forth below, the seat pan 42 moves forward, i.e., away from the seat back 18, during activation of the first energy absorbing device 36. As the seat pan 42 moves forward, the distance D2 increases and remains greater than the distance D1. Specifically, as shown in FIGS. 6A-E and discussed further below, since D2 is greater than D1 and since the second pivot points 52 are spaced above the first pivot points 50, the geometry of the links 46, 48 guide the seat pan 42 forward, i.e., away from the seat back 18, when the seat pan 42 moves relative to the seat bottom frame 22.

The first pivot point 50 of the first link 46 is fixed in position relative to the seat bottom frame 22 and the first link 46 is pivotable relative to the seat bottom frame 22 about the first pivot point 50. The second pivot point 52 of the first link 46 is slideably engaged with the seat pan 42. Specifically, the seat pan 42 defines a slot 54 and the second pivot point 52 of the first link 46 is slideably and pivotably engaged with the slot 54. The slot 54 extends between and terminates at a first end 56 and a second end 58. The second pivot point 52 of the first link 46 typically engages the first end 56 of the slot 54 under the bias of the first energy absorbing device 36 in the absence of a force at or above a force of the first magnitude.

As best shown in FIGS. 6A-E, the seat pan 42 defines a second slot 60 extending in parallel with the slot 54. The second pivot point 52 of the first link 46 engages the slot 54 in the figures. Alternatively, the second pivot point 52 of the first link 46 can engage the second slot 60. The motion of the seat pan 42 relative to the seat bottom frame 22 is different depending on the engagement of the second pivot point 52 in either the slot 54 or the second slot 60 and the choice between the slot 54 and the second slot 60 provides design options.

With reference to FIGS. 2 and 4, the first energy absorbing device 36 is disposed between the seat bottom frame 30 and the seat pan 42 o urge the seat pan 42 away from the seat bottom frame 30. Specifically, the first energy absorbing device 36 is coupled to the link 44 (e.g., all four links 44 as shown in the figures) for absorbing at least a portion of the force between the occupant and the vehicle 12 when the link 44 (e.g., all four links 44 as shown in the figures) pivots relative to the seat pan 42 and the seat bottom frame 22. Any number of first energy absorbing devices 36 can be disposed between the frame and the pan.

With reference to FIG. 4, the first energy absorbing device 36 is designed to maintain the seat pan 42 in position relative to the seat bottom frame 22 until the force reaches the first magnitude F1. In other words, in the absence of a force of the first magnitude F1, e.g., from a blast, the seat pan 42 does not move to support the occupant without loading the first energy absorbing device 36. When the force reaches or exceeds the first magnitude F1, the force overcomes the first energy absorbing device 36 and begins to load the first energy absorbing device 36. As the force overcomes the first resilient member, the pan moves relative to the frame, as shown in FIGS. 5 and 6B-E.

As one example, the first energy absorbing device 36 is a spring 62 resiliently disposed between the seat pan 42 and the seat bottom frame 22. The spring 62 is typically engaged with and fixed relative to the seat pan 42 and the seat bottom frame 22. The spring 62 is configured to resiliently compress between the seat pan 42 and the seat bottom frame 22 when subjected to a force at or above the first magnitude F1. Specifically, the spring 62 includes two bends 64 and one or both of the bends 64 resiliently flexes when subjected to a force at or above the first magnitude F1. The spring 62.

The spring 62 extends along a path between components of the seat 10. For example, the seat 10 can include upper cross members 66 and lower cross members 68 and the spring 62 is connected to the seat pan 42 and extends around one upper cross member 66. The spring 62 extends between the links 44 and is connected to the seat bottom frame 22. It should be appreciated that the spring 62 can follow any path.

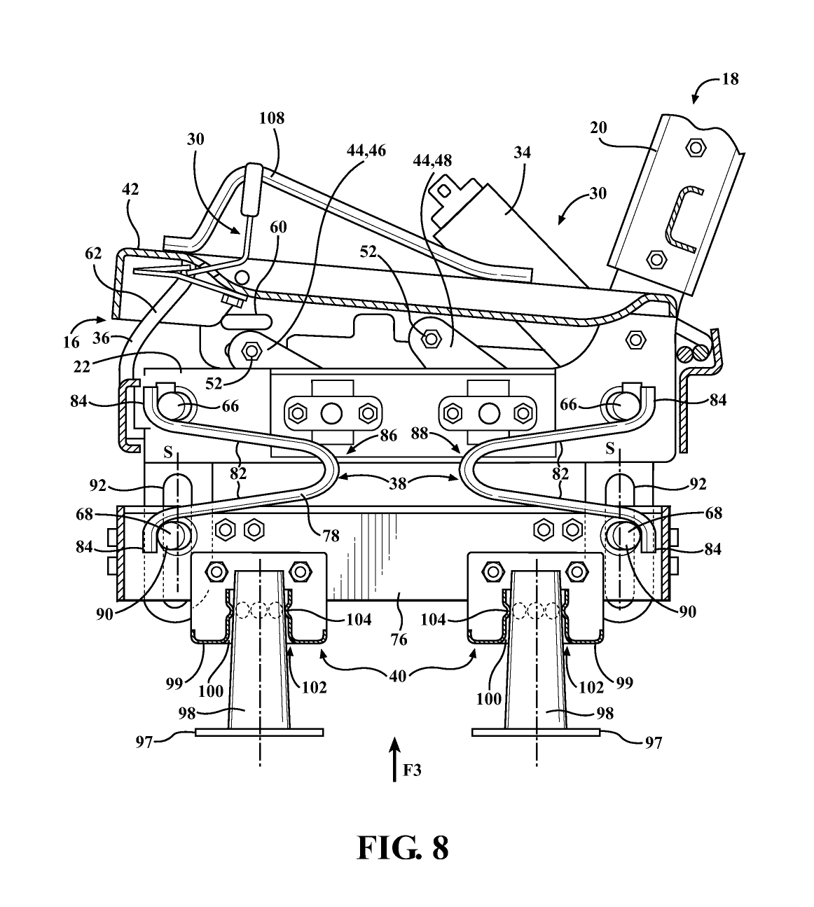

In the alternative to the spring 62, the first energy absorbing device 36 can be, for example, a torsion spring, a coil spring, a hydraulic damper, a pneumatic damper, etc. For example the first energy absorbing device 36 can be a torsion spring 70, i.e., a clock spring, connected to the seat bottom frame 22 and the links 44, as shown in FIGS. 8A-B.

FIG. 4 shows the position of the seat pan 42 relative to the seat bottom frame 22 in the absence of a force at or above a force of the first magnitude F1. FIG. 5 shows the seat pan 42 and the seat bottom frame 22 when subjected to a force at or above the force of the first magnitude F1. FIGS. 6A-E show a progression of movement of the seat pan 42 relative to the seat bottom frame 22 when subjected to a force at or above a force of the first magnitude F1. As shown in FIG. 4, the seat pan 42 slopes downwardly toward the seat back 18. Typically, in such a configuration, the seat pan 42 includes a front edge 72 and a rear edge 74 vertically spaced closer to the seat bottom frame 22 than the front edge 72. As shown in FIG. 6B, upon the application of a force of the first magnitude F1, the first link 46 and the second link 48 pivot relative to the seat bottom frame 22 and the seat pan 42. As the first link 46 pivots relative to the seat pan 42, the second pivot point 52 moves along the slot 54 from the first end 56 toward the second end 58. As shown in FIG. 6C, as the seat pan 42 continues to move toward the seat bottom frame 22, the first link 46 and the second link 48 pivot relative to the seat bottom frame 22 and the second pivot point 52 slides to the second end 58 of the slot 54. As the second pivot point 52 slides toward the second end 58 of the slot 54, the second pivot point 52 pulls the seat pan 42 toward the seat bottom frame 22. Specifically, the second pivot point 52 is disposed closer to the front edge 72 of the seat pan 42 than the rear edge 74 of the seat pan 42 such that the second pivot point 52 pulls the front edge 72 of the seat pan 42 toward the seat bottom frame 22. When the second pivot point 52 engages the second end 58 of the slot 54, the seat pan 42 is typically horizontal, as shown in FIG. 6C.

With reference to FIG. 6D, as the second pivot point 52 abuts the second end 58 of the slot 54, the second pivot point 52 forces the forces the seat pan 42 to moves along the seat bottom frame 22 and away from the seat back 18. Typically, the seat pan 42 moves horizontally when the second pivot point 52 engages the second end 58 of the slot 54. With reference to FIG. 6E, the seat back 18 continues to move horizontally and the second end 58 of the slot 54 separates from the second pivot point 52.

With reference to FIG. 5, the links 44 guide movement of the seat pan 42 relative to the seat bottom frame 22 toward the webbing 34 of the seat belt 30 the webbing 34 when the seat pan 42 moves relative to the seat bottom frame 22 for pre-tensioning the webbing 34 of the seat belt 30. Specifically, the retractor 32 is fixed relative to the seat bottom frame 22 and the seat back 18 and, as shown in FIGS. 6C and 6D, the seat pan 42 moves along the seat bottom frame 22 and away from the seat back 18 to pre-tension the webbing 34 of the seat belt 30 against the occupant when subjected to a force of a first magnitude F1. The pre-tensioning of the webbing 34 retains the occupant in the seat 10 to minimize the risk of whiplash of the occupant and to minimize the risk of “submarining” underneath the webbing 34, i.e., sliding underneath the webbing 34.

The first energy absorbing device 36 resiliently moves when absorbing at least a portion of the force. As such, as the force resides, the first energy absorbing device 36 returns to a pre-force position. In other words, the seat pan 42 and the first energy absorbing device 36 return to a position that the seat pan 42 and the first energy absorbing device 36 had before the force was applied, i.e., the position shown in FIGS. 4 and 6A.

With reference to FIGS. 2 and 3, a support 76 is spaced from the seat bottom frame 22 and the second energy absorbing device 38 is coupled to the seat bottom frame 22 and the support 76. The support 76 is disposed below the seat bottom frame 22 and moveably supports the seat bottom frame 22. The second energy absorbing device 38 is disposed between and coupled to the support 76 and the seat bottom frame 22 and is configured to absorb energy during relative movement of the seat bottom frame 22 and the support 76.

With reference to FIGS. 2 and 3, the second energy absorbing device 38 28 can include a plurality of resilient members 78 disposed between the upper cross members 66 and the lower cross members 68. Specifically, each resilient member 78 extends between one upper cross member 66 and one lower cross member 68. The resilient members 78 resiliently compress between the seat bottom frame 22 and the support 76 when subjected to a force at or above the second magnitude F2. In some embodiments, the resilient members 78 are configured to quickly rebound in the direction of the blast to minimize the effect of the blast on the occupant.

The resilient members 78 are, for example, torsion leaf springs. Each resilient member 78 includes a plurality of layered members 80. The layered members 80 are nested with each other. The layered members 80 are retained together to operate together as a unit to resiliently compress when subjected to a load. The layered members 80 are separate from each other, i.e., not fixed to each other, and can slide relative to each other when subjected to a load. The layered members 80 can, for example, be banded together (not shown) to retain the layered members 80 together as a unit. The figures show four layered members 80 and it should be appreciated that the resilient members 80 can include any number of layered members 80.

The resilient members 80 are U-shaped with two legs 82 spaced from each other that resiliently compress toward each other when subjected to a force at or above the second magnitude F2. The resilient members 80 are typically metal, for example, steel.

The resilient members 80 include two fingers 84 that extend transversely from the legs 82. One of the fingers 84 is retained between the upper cross member 66 and the seat bottom frame 22 and the other finger 84 is retained between the lower cross member 68 and the support 76. The engagement of the finger 84 between the cross members 66 and the seat bottom frame 22 and the engagement of the finger 84 between the cross member 68 and the support 76 retains the resilient member 78 between the seat bottom frame 22 and the support 76.

The resilient members 78 are arranged in a first row 86 and a second row 88. The first row 86 and the second row 88 shown in the figures include five resilient members 78. Alternatively, the first row 86 and the second row 88 can have any number of resilient members 78. The first row 86 and the second row 88 can have the same number of resilient members 78 or, alternatively, can have different numbers of resilient members 78. In the figures, the first row 86 is a front row and the second row 88 is a rear row. Alternatively, the rows 86, 88 can be positioned in different areas, e.g., as side rows.

Alternatively, as shown in FIGS. 9A-B, the second energy absorbing device 38 includes a linkage 170 and a second resilient member 172 operatively coupled to the linkage 170. The second resilient member 172 can be, for example, a shock absorber including a cylinder and a piston telescopically received in the cylinder. Such a shock absorber can be, for example, hydraulically or pneumatically operated. It should be appreciated that the second resilient member 172 can be of any suitable type without departing from the nature of the present invention.

With reference to FIGS. 9A-B, the linkage 170 includes a first pair 174 of links and a second pair 176 of links with the second resilient member extending between the first pair 174 of links and the second pair 176 of links. Each of the first 174 and second 176 pair of links includes an upper link 178 pivotally coupled to the seat bottom frame 22 and a lower link 189 pivotally coupled to the support 76. The upper 178 and lower 180 links of the first pair 174 of links are pivotally coupled to each other at a joint and the upper 178 and lower 180 links of the second pair 176 of links are pivotally coupled to each other at a joint.

In the configuration shown in FIG. 8A-B, the upper link 178 and the lower link 180 extend transversely to each other with the second resilient member 172 extending longitudinally therebetween. As such, when the second energy absorbing device 38 is loaded, the first pair of links 174 and the second pair of links 176 apply tension to the second resilient member 172, as discussed further below. Alternatively, the upper link 178 and the lower link 180 can extend transversely to each other away from the second resilient member 172, i.e., the second resilient member 172 extends longitudinally away from the upper link 178 and the lower link 180. As such, when the second energy absorbing device 38 is loaded, the first pair of links 174 and the second pair of links 176 apply compression to the second resilient member 172, as discussed further below.

The upper cross members 66 extend from the upper links 178 to the seat bottom frame 22 to couple the upper links 178 with the seat bottom frame 22. The upper cross members 66 typically extend through the upper links 178 and through the seat bottom frame 22 and each upper cross member 66 is pivotally coupled to at least one of the upper link 178 and the seat bottom frame 22. The lower cross members 68 extend from the lower link 180 to the support 76 to couple the lower link 180 to the support 76. The lower cross members 68 typically extend through the lower link 180 and through the support 76 and each lower cross member 68 is pivotally coupled to at least one of the lower link 180 and the support 76.

The second resilient members 172 are connected to and extend between the first 174 and second 176 pairs of links. Typically, the second resilient member 172 extends from the joint of the first pair 174 of links to the joint of the second pair 176 of links. Alternatively, the second resilient member 172 can be connected to the upper link 178 or the lower link 180 of the first 174 and/or second 176 pairs of links.

With reference to FIG. 2, a pin 90 extends from one of the seat bottom frame 22 and the support and the other of the seat bottom frame 22 and the support defines a slot 92 slideably receiving the pin 90. Specifically, the lower cross members 68 include the pin 90, i.e., a terminal end of the lower cross members 68. The seat bottom frame 22 includes an extension 94 with the slot 92 defined in the extension 94. The extension 94 extends between the seat bottom frame 22 and the support 76 and, more specifically, from the seat bottom frame 22 to the support 76. As best shown in FIG. 3, the seat 10 includes four pins 90 and four corresponding slots 92, however, the seat 10 can include any number of pins 90 and slots 92 without departing from the nature of the present invention.

The slot 92 extends along an axis S for limiting relative movement of the seat bottom frame 22 and the support along the axis S. The axis S of the slot 92 is vertical. As such, the slot 92 limits movement of the seat bottom frame 22 relative to the support 76 to a vertical movement when the second energy absorbing device 38 is activated in response to a force of the second magnitude F2.

As shown in FIG. 2, guides 96 extend from the support 76 and engage the extension 94 for guiding the extension 94 along the axis S. The guides 96 define a track that receives the extension 94 as the extension 94 moves along the axis S. The guides 96 shown in the figures are in the form of a plate. Alternatively, for example, the guides 96 can be pegs, slotted members, etc.

The second energy absorbing device 38 is designed to maintain the seat bottom frame 22 in position relative to the support 76 until the force reaches the second magnitude F2. In other words, in the absence of a force of a second magnitude F2, e.g., from a blast, the seat bottom frame 22 does not move and supports the occupant without loading the second energy absorbing device 38, as shown in FIGS. 5 and 6A-E. As shown in FIG. 6, when the force reaches or exceeds the second magnitude F2, the force overcomes the second energy absorbing device 38 and begins to load the second energy absorbing device 38. As the force overcomes the second energy absorbing device 38, the seat bottom frame 22 moves relative to the support 76.

For example, in the configuration of the second energy absorbing device 38 of FIGS. 2 and 3, the upper cross members 66 and lower cross members 68 transmit force to the resilient members 70. If the force reaches the second magnitude F2, the resilient members 70 resiliently deform to absorb energy.

In the configuration of the second energy absorbing device 38 of FIGS. 9A-B, during a blast, force is transmitted through the seat 10 to the first 174 and second 176 pair of links. This force urges the upper 174 and lower 176 links to pivot about the joints, respectively. The second energy absorbing device 38 is configured such that, if a force of the second magnitude F2 is applied to the seat 10, the force on the upper 174 and lower 176 links overcome the second resilient member 172 such that the upper 174 and lower 176 links pivot about the joints, respectively. In other words, the upper 174 and lower 176 links move in a scissor-like motion. The second energy absorbing device 38 resiliently moves when absorbing at least a portion of the force. As such, as the force resides, the second energy absorbing device 38 returns to a pre-force position. In other words, the seat bottom frame 22 returns to a position that the seat bottom frame 22 had before the force was applied, i.e., as shown in FIG. 4.

The second energy absorbing device 38 extends between the first energy absorbing device 36 and the third energy absorbing device 40. The second energy absorbing device 38 supports the first energy absorbing device 36. Specifically, the second energy absorbing device 38 supports the seat bottom frame 22 so that the first energy absorbing device 36 transmits a portion of the force to the second energy absorbing device 38 when the force exceeds the first magnitude F1. In other words, the second energy absorbing device 38 acts as a foundation for the first energy absorbing device 36. As set forth above, when the magnitude of the force is less than the second magnitude F2, the second energy absorbing device 38 remains deactivated and the seat bottom frame 22 maintains position relative to the support, as shown in FIG. 4. If the magnitude of the force loads the first energy absorbing device 36 to the fully loaded state, i.e., a force greater than the second magnitude F2, the first energy absorbing device 36 is unable to absorb additional force and instead transmits additional force to the second energy absorbing device 38.

The third energy absorbing device 40 moveably supports the support 76 and is configured to absorb energy during movement of the support relative to the third energy absorbing device 40. In particular, with reference to FIGS. 2 and 3, the seat 10 includes a base 97 for connecting to the vehicle 12. The base 97 is mounted to the vehicle 12 and supports the third energy absorbing device 40. With reference to FIGS. 7 and 8, the third energy absorbing device 40 includes a cup 99 attached to one of the base 97 and the support 76 and a rod 98 attached to the other of the base 97 and the support 76. For example, as shown in FIGS. 6 and 7, the cup 99 is connected to the support 76 and the rod 98 extends from the base 97 upwardly into the cup 99. It should be appreciated that the base 97 can be integral with the cup 99 or rod 98 (i.e., formed as one piece with the cup 99 or rod 98), or can be formed separately from the cup 99 or rod 98 and subsequently attached.

The cup 99 includes an interior wall 100 that defines a cavity 102 receiving the rod 98. The rod 98 abuts the interior wall 100. The interior wall 100 can include protrusions 104 that extend into the cavity 102 and abut the rod 98. The rod 98 tapers from the base 97 toward the protrusions 104.

The third energy absorbing device 40 limits movement of the support relative to the third energy absorbing device 40 along the axis S, i.e., in a direction parallel to axis S, and specifically limits the support to vertical movement. Specifically, the cup 99 receives the rod 98 along the axis S, i.e., in a direction parallel with the axis S, for limiting movement of the support 76 along the axis S. As set forth above, the movement of the seat bottom frame 22 relative to the support 76 is limited to movement along the axis S, and specifically is limited to vertical movement, during operation of the second energy absorbing device 38. Since the movement of the seat bottom frame 22 relative to the support 76 and movement of the support 76 relative to the third energy absorbing device 40 are limited to movement along the axis S, specifically limited to vertical movement, the operational space required by seat 10 in the vehicle 12 is reduced and the likelihood of contacting the knees o the occupant against other components of the vehicle 12 during operation of the second 38 and third 40 energy absorbing devices is reduced. Also, the second energy absorbing device 38 and third energy absorbing device 40 can be independently tuned to vary the absorption of energy along the axis S.

The third energy absorbing device 40 is designed to maintain the support 76 in position relative to the base 97 until the force reaches the third magnitude F3. In other words, in the absence of a force of the third magnitude F3, e.g., from a blast, the support 76 does not move and supports the occupant, as shown in FIG. 4. When the force reaches or exceeds the third magnitude F3, the force overcomes the third energy absorbing device 40. As the force overcomes the third energy absorbing device 40, the support moves toward the base 97 as shown in FIG. 8.

Specifically, when the force reaches the third magnitude F3, the rod 98 is forced deeper into the cavity 102 and the rod 98 and/or the protrusions 104 plastically deform to absorb at least a portion of the force, as shown in FIG. 8. After the blast, the third energy absorbing device 40 is typically replaced since the rod 98 and/or the protrusions 104 are plastically deformed.

The rod 98 and the cup 99 are typically formed of steel. Alternatively, the rod 98 and cup 99 can be formed of any type of material suitable for deform to absorb energy.

The third energy absorbing device 40 extends between the base 97 and the second energy absorbing device 38. The third energy absorbing device 40 supports the second energy absorbing device 38. Specifically, the third energy absorbing device 40 supports the support 76 so that the second energy absorbing device 38 transmits a portion of the force to the third energy absorbing device 40 when the force exceeds the second magnitude F2. In other words, the third energy absorbing device 40 acts as a foundation for the second energy absorbing device 38. As set forth above, when the magnitude of the force is less than the third magnitude F3, the third energy absorbing device 40 remains stationary and the support 76 maintains position relative to the base 97, as shown in FIG. 4. If the magnitude of the force loads the second energy absorbing device 38 to the fully loaded state, i.e., a force greater than the third magnitude F3, the second energy absorbing device 38 is unable to absorb additional force and instead transmits additional force to the third energy absorbing device 40.

The first 36, second 38, and third 40 energy absorbing device 40 shown in the figures are exemplary and the first 36, second 38, and third 40 energy absorbing device 40 can be of any type without departing from the nature of the present invention. The seat 10 can include one or any combination of two of the first 36, second 38, and third 40 energy absorbing device 40 without departing from the nature of the present invention. The seat 10 can also include any number of additional energy absorbing devices in addition to the first 36, second 38, and third 40 energy absorbing device 40 without departing from the nature of the present invention. A manufacturer of the seat 10 can pick and choose any combination of the first 36, second 38, and third 40 energy absorbing device 40 and any additional energy absorbing devices based on varying weight, cost, and performance criteria.

Various configurations of the base 97 are shown in the figures. The seat 10 can include one or more bases 97 and one or more third energy absorbing devices 40. For example, in the configuration shown in FIG. 3, the base 97 includes four mounting brackets each supporting one of the third energy absorbing devices 40. In such a configuration, each mounting bracket, for example, can be bolted to the floor of the vehicle 12. Alternatively, the base includes a bracket for being mounted to an interior wall, e.g., a bulkhead, of the vehicle 12. The bracket supports each of the third energy absorbing device 40s. The bracket can be, for example, bolted to the interior wall. In such a configuration, the bracket is cantilevered from the interior wall. In another configuration, the base includes a pedestal, e.g., a cylindrical pedestal, and a tray supported on the pedestal. In such a configuration, the seat 10 can be rotatably attached to the pedestal such that the seat 10 can swivel relative to the pedestal. Alternatively, the seat 10 can be fixed relative to the pedestal. The pedestal can be, for example, bolted to the floor of the vehicle 12.

The base 97 supports the rest of the seat 10 in the vehicle 12 such that the seat 10 is modular, i.e., self contained. The entire seat 10 can be installed into or removed from the vehicle 12 by merely disconnecting the base from the vehicle 12. This modular arrangement also allows for one or more seats 10 to be easily installed in various seat 10ing configurations in the vehicle 12. In addition, the seat 10 can be easily removed from the vehicle 12 for replacement or service.

As set forth above, the blast may cause the vehicle 12 to become airborne, which results in an event called a “slam down” when the vehicle 12 lands. The seat 10 can include an inflatable device (not shown) such as, for example, an airbag to cushion the occupant on the slam down. In other words, the inflatable device increases the “ride down time.” As set forth above, the first 36 and second 38 energy absorbing devices are resilient and, as such, the first 36 and second 38 energy absorbing devices can reset before the slam down. The inflatable device can aid the reset first 36 and second 38 energy absorbing devices on slam down. The inflatable device can also provide the primary energy absorption in the event that the first 36 and/or second 38 energy absorbing device do not reset before the slam down.

The inflatable device can be, for example, disposed on the seat pan 42 of the seat bottom 16 and/or the seat back 18 and is configured to selectively inflate for cushioning between the occupant and the seat pan 42. The inflatable device is configured to inflate when the vehicle 12 is airborne so that the inflatable device can immediately absorb energy when the vehicle 12 lands. The inflatable device can also be positioned on the seat pan 42 to prevent “submarining” of the occupant as discussed further below. The inflatable device includes a bag that is typically formed of a shrapnel-resistant material such as, for example, Nomex and/or Kevlar.

The inflatable device can include, for example, a computer (not shown) having a sensor for sensing the blast and inflating the inflatable device. The computer can be programmed such that, for example, the inflation of the inflatable device can be delayed so that the inflatable device does not interfere with the energy absorption of the first 36, second 38, and third 40 energy absorbing devices. After the initial delay, the inflatable device is inflated before the vehicle 12 lands. For example, the computer can be programmed such that the airbag inflates 25-150 milliseconds after the blast.

Alternatively, the computer can calculate the proper inflation delay based on the details of the blast. In such a configuration, the inflatable device includes sensors (not shown) for measuring characteristics such as location and magnitude of the blast. Based on these measurements, the computer calculates the effect of the blast on the vehicle 12 and instructs the airbag to inflate at a time when the vehicle 12 is calculated to be in the air.

With reference to FIGS. 9A-B, the seat 10 can include a footrest 106, i.e., a foot isolator, connected to the base for supporting the feet of the occupant spaced from the floor of the vehicle 12. The footrest 106 isolates the occupant from the floor of the vehicle 12. Such a configuration prevents force from being transferred from the floor of the vehicle 12 to the feet of the occupant.

An anti-submarine feature 108 can be coupled to the seat bottom frame 22 to provide resistance to “submarining” of the occupant during a blast, i.e., to prevent the occupant from moving forward on the seat bottom 16 and sliding underneath the seat belt 30. The anti-submarine feature 108 typically includes a thigh support pivotally coupled to the seat bottom frame 22. In a scenario where the blast causes the occupant to move forward and/or downwardly in the seat 10, force applied to the thigh support by thighs of the occupant causes the thigh support to rotate to prevent further forward movement of the occupant.

With reference to FIGS. 9A-B, the seat 10 includes an active head restraint 110. The active head restraint 110 is typically pivotally coupled to the seat back frame 20. Specifically, the active head restraint includes a frame 116 mounted to the seat back frame 20 at a pivot point 118. In the scenario where the occupant is pushed back into the seat 10, e.g., during a blast, the active head restraint 110 pivots forwardly toward the head of the occupant to reduce the whiplash of the occupant.

The active head restraint 110 can be moved between a stowed position, as shown in FIG. 9A, and a deployed position, as shown in FIG. 9B. The active head restraint 110 includes two pads 112 for receiving the head of the occupant therebetween when the active head restraint 110 is in the deployed position. The two pads 112 are fixed in position relative to each other and move together between the stowed position and the deployed position. Specifically, a cross-member 120 is connected to the two pads 112 to fix the two pads 112 relative to each other.

In the stowed position, the two pads 112 are in a position to allow for easy entry and exit to the seat 10. The active head restraint 110 can include handles, typically extending from the two pads 112. The pads 112 are spaced from each other to fit a helmet or other headgear and/or communication equipment (not shown) worn by the occupant.

The pads 112 each include bottom surfaces 114 that rest on the shoulders of the occupant when the seat 10 is in the deployed state. As such, the active head restraint 110 is self-adjusting based on the shoulder height of the occupant. In other words, under the force of gravity, the active head restraint 110 pivots to the proper position to rest on the shoulders of the occupant when the active head restraint is in the deployed position.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. A seat for supporting an occupant of a vehicle and absorbing a force between the occupant and the vehicle created by relative movement between the occupant and the vehicle, said seat comprising:
a seat bottom frame;
a seat back supported on said seat bottom frame;
a support coupled to and moveably supporting said seat bottom frame;
an energy absorbing device coupled to said support to absorb energy during relative movement of said seat bottom frame and said support;
a pin extending from one of said seat bottom frame and said support and the other of said seat bottom frame and said support defining a slot slideably receiving said pin with said slot extending along an axis to limit relative movement of said seat bottom frame and said support along said axis and said pin moving within said slot during said relative movement of said seat bottom frame and said support, with said energy absorbing device resisting said movement of said pin within said slot.

2. The seat as set forth in claim 1 further comprising another energy absorbing device moveably supporting said support and configured to absorb energy during movement of said support relative to said another energy absorbing device.

3. The seat as set forth in claim 2 wherein said another energy absorbing device limits movement of said support relative to said another energy absorbing device along said axis.

4. The seat as set forth in claim 2 wherein said another energy absorbing device includes a rod and a cup coupled to said support, said cup receiving said rod along said axis for limiting movement of said support along said axis.

5. The seat as set forth in claim 1 wherein the other of said seat bottom frame and said support includes an extension with said slot defined in said extension.

6. The seat as set forth in claim 5 wherein said extension extends between said seat bottom frame and said support.

7. The seat as set forth in claim 5 further comprising guides extending from the one of said seat bottom frame and said support and engaging said extension for guiding said extension along said axis.

8. The seat as set forth in claim 1 wherein said axis is vertical.

9. A seat for supporting an occupant of a vehicle and absorbing a force between the occupant and the vehicle created by relative movement between the occupant and the vehicle, said seat comprising:
a seat bottom frame for mounting to the vehicle and supporting the occupant;
a seat pan moveably coupled to said seat bottom frame for supporting the occupant;
a seat belt including a retractor and webbing extending from said retractor for extension across the occupant to retain the occupant on the seat pan; and
a link pivotably coupled to said seat pan and to said seat bottom frame and guiding movement of said seat pan relative to said seat bottom frame toward said webbing of said seat belt said webbing when said seat pan moves relative to said seat bottom frame for pre-tensioning the webbing relative to the occupant.

10.-12. (canceled)

13. The seat as set forth in claim 1 further comprising a seat pan moveably coupled to said seat bottom frame and another energy absorbing device coupled between said seat bottom frame and said seat pan to absorb at least a portion of the force between the occupant and the vehicle when said seat pan moves relative to said seat bottom frame.

14.-21. (canceled)

22. The seat as set forth in claim 1 wherein said energy absorbing device is further defined as a plurality of resilient members that resiliently compress between said seat bottom frame and said support during said relative movement of said seat bottom frame and said support.

23. The seat as set forth in claim 22 wherein each of said resilient members are further defined as a plurality of layered members.

24. The seat as set forth in claim 23 wherein said plurality of layered members are nested with each other and operate together as a unit.

25. The seat as set forth in claim 22 wherein said resilient members are further defined as torsion leaf springs.

26. The seat as set forth in claim 22 wherein said resilient members are U-shaped with two legs spaced from each other that resiliently compress toward each other during said relative movement of said seat bottom frame and said support.

27. The seat as set forth in claim 22 wherein said resilient members are arranged in a first row and a second row.

28. The seat as set forth in claim 27 wherein each row of resilient members has the same number of resilient members.

29. The seat as set forth in claim 1 further comprising guides extending from said support for guiding said movement of said seat bottom frame relative to said support.

30. The seat as set forth in claim 1 wherein said energy absorbing device is further defined as a first energy absorbing device for absorbing at least a portion of the force when the force reaches a first magnitude, and further including:
a second energy absorbing device for absorbing at least a portion of the force when the force reaches a second magnitude greater than the first magnitude with said second energy absorbing device coupled to said first energy absorbing device so that said first energy absorbing device transmits a portion of the force to said second energy absorbing device when the force reaches the second magnitude; and
a third energy absorbing device coupled to said second energy absorbing device for absorbing a portion of the force from the second energy absorbing device when the force reaches a third magnitude greater than the second magnitude.

31. The seat as set forth in claim 30 wherein said third energy absorbing device is configured to plastically deform to absorb at least a portion of the force when the force exceeds the third magnitude.

32. The seat as set forth in claim 4 wherein said another energy absorbing device includes a base with said rod and said cup disposed between said base and said support.

33. The seat as set forth in claim 13 wherein said another energy absorbing device is further defined as a spring having at least one bend.
